(19) United States
(12) Patent Application Publication
(10) Pub. No.: US 2012/0312631 A1
(43) Pub. Date: Dec. 13, 2012

(54) MULTI-LAYERED COMPOSIT PANEL FOR NOISE MITIGATION AND METHOD

(75) Inventor: Gregory E. Curfman, Jackson, MI (US)

(73) Assignee: UFP TECHNOLOGIES, INC., Georgetown, MA (US)

(21) Appl. No.: 13/478,724

(22) Filed: May 23, 2012

Related U.S. Application Data
(60) Provisional application No. 61/494,124, filed on Jun. 7, 2011.

(51) Int. Cl. G10K 11/168; B29C 43/00

(52) U.S. Cl. 181/286; 264/137

(57) ABSTRACT

The invention is directed at methods, materials, and articles for sound mitigation. The article for sound mitigation is a multi-layered composite article comprising a reinforcing substrate layer and a foam layer. The reinforcing substrate layer includes a fiber phase and a polymer phase. The fiber phase preferably includes one or more natural fibers. The natural fibers may be present at a concentration of about 60 wt. % or more, based on the total weight of the reinforcing substrate layer. The polymer phase is preferably a continuous phase and preferably has a glass transition temperature sufficiently high so that the panel maintains its stiffness at elevated temperatures. The concentration of the polymer phase may be about 10 wt. % or more, based on the total weight of the reinforcing substrate layer. Preferably both the foam layer and the reinforcing substrate layer are effective in reducing the transmission of a sound.

### CLAIM OF PRIORITY

The present application claims the benefit of the filing date of U.S. Provisional Patent Application 61/494,124 filed on Jun. 7, 2011, which is incorporated herein by reference in its entirety for all purposes.

### FIELD OF THE INVENTION

The present invention relates to novel panels for reducing noise (e.g., noise transmission), to novel methods for preparing the panels and/or precursor components, and to the use of the panels.

### BACKGROUND OF THE INVENTION

Panels for mitigating noise are generally known in the art for absorbing sound or otherwise blocking its transmission. For example a panel may be employed between a sound source (e.g., a sound generator) and a sound receptor, so that the level of the sound from the sound source that reaches the sound receptor is reduced or eliminated.

The current use of plywood panels requires generally thick panels to achieve the needed stiffness. Such panels are typically heavy (e.g. difficult for a single person to handle), provide insufficient sound barrier properties, and may not meet flammability requirements.

There is a need for panels having one or any combination of the following features: easy to manufacture; low cost materials and/or processes; light weight (e.g., for ease of handling); good sound dampening characteristics of the panel; good sound damping (e.g., absorbing) of a natural-fiber reinforced layer of the panel; capable of being custom colored; having a finished surface (such as a textured surface, e.g., produced from a molding process, preferably without the need for subsequent coloring and/or surface treatments); including a molded-in a logo or other graphical and/or textural feature, resistant to water; resistant to distortion upon exposure to high temperature (e.g., about 150° C.), resistant to distortion upon exposure to high humidity (e.g., at elevated temperature); generally inflammable (e.g., meets or exceeds requirements of FMVSS-302, CAL 117, UL94, E84 Class C, or any combination thereof); includes materials from renewable sources; includes a foam component (e.g., a foam component attached using an adhesive, such as a non-volatile adhesive).

### SUMMARY OF THE INVENTION

One aspect of the invention is directed at a multi-layered composite article for sound mitigation comprising reinforcing substrate layer and a foam layer. The reinforcing substrate layer may have opposing first and second surfaces and a thickness of about 5 mm or less. The reinforcing substrate layer includes a fiber phase and a polymer phase. The fiber phase may be a discrete phase or a continuous phase and preferably includes one or more natural fibers. The natural fibers may be present at a concentration of about 60 weight percent or more, based on the total weight of the reinforcing substrate layer so that the reinforcing substrate layer has a stiffness greater than the stiffness of the polymer. The polymer phase is preferably a continuous phase and preferably has a glass transition temperature sufficiently high so that the panel maintains its stiffness at elevated temperatures. For example, the polymer phase may have a glass transition temperature of about 100° C. or more. The concentration of the polymer phase may be about 10 weight percent or more, based on the total weight of the reinforcing substrate layer. The reinforcing substrate layer may have a volume density sufficiently low so that the panel can be easily handled. For example the reinforcing substrate may have a volume density of about 1.5 g/cm² or less. The foam layer may be disposed on at least a portion of the first surface or the second surface of the reinforcing substrate layer. The foam layer may have a density sufficiently low so that the panel can easily be handled, so that the foam layer efficiently reduces sound transmission, or both. For example, the foam layer may have a density of about 0.6 g/cm³ or less. The foam may be an open cell foam or a closed cell foam. The reinforcing substrate layer preferably has a sufficient resistance to moisture so that an open cell foam may be employed. The reinforcing substrate layer may reduce the transmission of one or more of sounds having a frequency from about 20 Hz to about 20 kHz, the foam layer may reduce the transmission of one or more sounds having a frequency from about 20 Hz to about 20 KHz, or preferably both, so that the article reduces the transmission of a sound having a frequency in the range from about 20 Hz to about 20 kHz by about 10 dB or more.

Another aspect of the invention is directed at a method for preparing a composite article according to the teachings herein, the method comprising the steps of: impregnating a mat with a polymer solution, and curing the polymer in a mold. The process may further include a step of partially drying the impregnated mat to form a dried impregnated mat, prior to the step of curing the polymer in a mold. The mat may includes one or more natural fibers and has open spaces. The polymer solution may includes one or more polymers and a sufficient amount of water so that the polymer solution can flow into the open spaces of the mat to form an impregnated mat. Preferably the step of partially drying the impregnated mat to form a dried impregnated mat results in a dried impregnated mat that is sufficiently dried (i.e., has a sufficient reduction in the water concentration) and/or is characterized by a polymer that is partially cured, so that the dried impregnated mat can be handled as a solid and so that the polymer does not flow out of the mat. The concentration of water in the dried impregnated mat may be sufficiently high so that the polymer can be cured to a higher level of cure, so that the polymer can be cured at lower temperatures, or both. For example, the concentration of water in the dried impregnated mat may be about 10 wt. % or more, based on the total weight of the water and the one or more polymers. The step of curing the polymer in a mold may include a pressure and may be at a sufficiently high curing time and curing temperature so that the polymer has a glass transition temperature greater than about 100° C., and the impregnated mat becomes a reinforcing substrate. Thus formed, the reinforcing substrate is a light weight composite article. The method preferably includes a step of attaching a foam layer to the reinforcing substrate layer.

### BRIEF DESCRIPTION OF THE DRAWINGS

The present invention is further described in the detailed description which follows, in reference to the noted plurality of drawings by way of non-limiting examples of embodiments of the present invention, in which like reference numerals represent similar parts throughout the several views of the drawings, and wherein:

FIG. 1 is a schematic drawing of an illustrative wall or chamber (e.g., a sound isolation wall or chamber) including a composite article according to the teachings herein that may be used as an access panel (e.g., for accessing the interior of the chamber).

FIG. 2 is a schematic drawing illustrating features of an article according to the teachings herein, including a reinforcing substrate layer and a foam layer.

FIG. 3 is an illustrative front view of a reinforcing substrate layer.

FIG. 4 is a schematic drawing of an illustrative reinforcing substrate layer including features according to the teachings herein.

FIG. 5A is a front view of an article showing an illustrative reinforcing substrate layer.

FIG. 5B is an illustrative cross-section of the article of FIG. 5A showing features of the components of the article according to the teachings herein.

FIG. 5C is a rear view of an illustrative article.

FIG. 5D is a bottom view of an illustrative foam layer.

FIG. 5E is an edge view of an illustrative foam layer.

FIG. 5F is a cross-section of an illustrative foam layer.

FIG. 6A is a photograph of an arcuate surface of an illustrative foam layer according to the teachings herein.

FIG. 6B is a top view of an illustrative foam layer having a non-planar top surface.

FIG. 7 is photograph of an illustrative panel according to the teachings herein.

FIG. 8 is a photograph of an illustrative mold that may be used to produce a reinforcing substrate layer according to the teachings herein.

### DETAILED DESCRIPTION

In the following detailed description, the specific embodiments of the present invention are described in connection with its preferred embodiments. However, to the extent that the following description is specific to a particular embodiment or a particular use of the present techniques, it is intended to be illustrative only and merely provides a concise description of the exemplary embodiments. Accordingly, the invention is not limited to the specific embodiments described below, but rather; the invention includes all alternatives, modifications, and equivalents falling within the true scope of the appended claims.

One aspect of the invention is directed at a multilayered composite article for sound mitigation comprising reinforcing substrate layer and a foam layer. According to the teachings herein, the composite article has a surprising balance of properties including one or any combination of the following features: the composite article and/or the reinforcing substrate layer is generally light weight (e.g., having a generally low volume density, a generally low area density, or both, such as a volume density and/or area density lower than that of a reinforcing substrate layer that consists essentially of a glass reinforced polymer, or a composite article made therefrom); the composite article includes one or more natural and/or renewable materials; the reinforcing substrate layer may have a generally high temperature heat resistance; the composite article or the reinforcing substrate layer includes a colorant (e.g., the composite article may include a molded-in colorant); the composite article includes a thermoset material (preferably a thermoset material that includes, or is a natural and/or renewable material); the composite article and/or the reinforcing substrate layer is generally flame resistant; or the reinforcing layer includes a molded-in embossment and/or texture.

The composite article may be configured as a panel, such as a panel that is sufficiently rigid to be self-supporting. The composite article may be used to close or otherwise cover an opening, such as an opening to a wall or chamber. By way of example, the chamber may be a sound isolation chamber and the wall may be a wall of a chamber, or a sound barrier wall. For example, the chamber or wall may include a sound or sound source on one side of the chamber (either inside the chamber or outside the chamber) or wall and the chamber or wall may reduce or substantially eliminate the transmission of the sound from one side of the chamber to the other side. The composite article may be used in a process including a step of covering the opening with the composite article so that the level of the sound (e.g., the sound from a sound source on one side of the wall or chamber) observed in a region on the other side of the wall or chamber is substantially reduced. It will be appreciated that the composite articles according to the teachings herein may also be used in other applications that will take advantage of one or more of the aforementioned characteristics.

The sound isolation chamber may include one or more sound generating devices or machines. The sound isolation chamber preferably functions to reduce the level of noise outside of the chamber compared to the level of noise inside the chamber. As such, the composite article may reduce or substantially eliminate the transmission of sound through the region of the opening. The composite article preferably functions as an access panel so that an individual may access the interior of the sound isolation chamber and/or pass through a sound barrier wall. It will be appreciated, that one or more noise generating sources may be located within the sound isolation chamber or outside of the sound isolation chamber.

The composite article includes a reinforcing substrate layer and a foam layer preferably disposed thereon. The foam layer may disposed over a portion of, or even all of a surface of the reinforcing substrate layer. Preferably, the foam layer is disposed over substantially all of a surface of the reinforcing layer. A foam layer may be disposed on one or both sides of the reinforcing substrate layer. For example, the foam layer may be disposed on the side that is intended to face towards a noise generating source and/or on the side that is intended to face away from a noise generating source. If the noise generating source is inside a sound isolation chamber, a foam layer preferably is disposed on a surface of the reinforcing substrate layer that faces towards the interior of the sound isolation chamber. If the noise generating source is outside a sound isolation chamber, a foam layer preferably is disposed on a surface of the reinforcing substrate layer that faces away from the interior of the sound isolation chamber. Preferably, the composite article does not include a foam layer disposed on a surface of the reinforcing substrate layer that is intended to face away from the noise generating source, so that one or more features of the surface of the reinforcing substrate layer is visible from the side of the sound isolation chamber opposite from the noise generating source. The foam layer may have one or more surfaces (e.g., a surface facing toward the reinforcing substrate layer and/or a surface facing away from the reinforcing substrate layer) that are generally planar. The foam layer may have one or more surfaces (e.g., a surface facing toward the reinforcing substrate layer and/or a surface facing away from the reinforcing substrate layer) that is generally nonplanar (e.g., generally arcuate). For example, the foam layer may have one surface that is generally planar, and an opposing surface that is generally arcuate. The nonplanar surface of the foam layer may have a pattern, such as a repeating pattern, including a plurality of peaks and a plurality of valleys. For example, the nonplanar surface may have a plurality of convolutes that form peaks and valleys. As another example, the nonplanar surface may including pyramid shaped structures, that form peaks and valleys.

The reinforcing substrate layer may have a front side (e.g., a surface of the front side) that is intended to face away from the sound generating device. The front side of the reinforcing substrate layer may face toward the inside of a sound isolation chamber or may face toward that outside of the sound isolation chamber. The front side of the reinforcing substrate layer preferably includes one or more features that are visible (e.g., that are visible on the composite article). For example, the front side of the reinforcing substrate layer may include one or more decorative features that cover one or more regions (or even the entirety) of the front side. If employed, the decorative feature may be any feature that improves the aesthetics compared with a generally smooth uncolored surface. Examples of decorative features that may be employed include one or more embossed regions (e.g., an embossed region that is formed during a step of molding the reinforcing substrate layer), one or more textured regions e.g., a texture that is formed during a step of molding the reinforcing substrate layer), one or more molded-in colors, or any combination thereof.

The reinforcing substrate layer preferably includes one or more structural features, such as a structural feature that increases the rigidity of the reinforcing substrate layer. Example of structural features that may increase the rigidity of the reinforcing substrate layer include one or more ribs, one or more regions having increased thickness, one or more elongated edges, one or more beam sections, one or more locally raised sections, or any combination thereof. For example, the reinforcing substrate layer may include a region that has a thickness that is about 50% or more greater than the average thickness of the reinforcing substrate layer. Preferably the reinforcing substrate layer has at least one depth that is about 50% or more greater than the average wall thickness, at least one region that has a wall thickness about 50% or more greater than the average wall thickness, or both. The reinforcing substrate layer may have an edge surface, such as along one or more of (e.g., all of) the edges of the reinforcing substrate layer. As such, the reinforcing substrate layer may have a generally tray like shape.

The reinforcing substrate layer may have a shape suitable for accommodating a foam layer (e.g., so that the foam layer is generally maintained within the space defined by the boundaries of the reinforcing substrate layer. Preferably, the thickness of the foam layer (e.g., the maximum thickness of the foam layer) is equal to, or less than the depth of the reinforcing substrate layer. For example, the depth of the reinforcing substrate layer and the thickness of the article may be the same. The rear surface of the article (e.g., the panel) may be adapted for facing the sound generating device (e.g., the interior of a chamber including a sound source). The rear surface of the article may include or consist substantially of the foam layer. A minor portion of the rear surface of the reinforcing substrate layer may be visible, such as in a region near the outer periphery of the article.

The reinforcing substrate layer may include one or more features for attaching the reinforcing substrate layer to a frame or another panel of a wall or sound isolation chamber. For example, the reinforcing substrate layer may include one or more attachment openings, such as an opening suitable for accommodating a screw, bolt, nail, or other fastener. The reinforcing substrate layer preferably has one or more holes of sufficient size and number so that the reinforcing substrate layer can be attached to a periphery of the opening (e.g., attached to a frame at the periphery of the opening).

The reinforcing substrate layer may be capable of cover an opening that is sufficiently large that a person can easily pass through, e.g., crawl through, crouch through, or even walk through.

The foam layer preferably has a first side for disposing onto a reinforcing substrate layer and a second opposing side. The first side may be generally flat (e.g., generally planar), or may have a contour. Preferably, the first side is generally flat so that the foam layer can easily be attached to a reinforcing substrate layer (e.g., attached to a generally planar section of a reinforcing substrate layer). The second side of the foam layer may be generally flat, or may have a contour. Preferably, the second side has a contour, so that the total surface area of the second side is greater than the total surface area of the first side. For example, the second side of the foam layer may have a generally arcuate (e.g., convoluted) surface so that the foam layer can efficiently absorb sound. The foam layer may have a minimum thickness and a maximum thickness, wherein the ratio of the minimum thickness to the maximum thickness is about 1.0 or less, about 0.95 or less, about 0.85 or less, about 0.7 or less, about 0.6 or less, or about 0.5 or less. The ration of the minimum thickness to the maximum thickness of the foam layer may be about 0.05 or more, preferably about 0.2 or more, and more preferably about 0.35 or more.

The foam layer may be attached to the reinforcing substrate layer by any suitable means, such as by heat bonding, vibration welding, or by an adhesive layer. For example, the foam layer may be attached to the reinforcing substrate layer using an adhesive layer, such as an adhesive layer interposed between the foam layer and the reinforcing substrate layer. The foam layer preferably is attached to a sufficiently large portion of the reinforcing substrate layer so that the foam layer remains in place during handling and use of the article. As such, there may be regions of the foam layer, where the foam layer is not directly attached to the reinforcing substrate layer. For example, a reinforcing substrate layer that includes a region with a rib or other raised section may have a gap, such as an air gap, between the foam layer and the reinforcing substrate layer in that region. The gap may includes or be filled with one or more materials that decouples sound waves, such as air, foam, fluid, gel, or any combination thereof.

It will be appreciated that the composite article may include one or more features or components known to those generally skilled in the art that may assist in the opening and closing of the article, that may improve the appearance of the composite article, or any combination thereof. Without limitation, the composite article may include a handle, a handle insert, an opening for a handle insert, a trim, or any combination thereof.

The composite article may have a first surface that is generally visible. For example, the first surface may is intended to face away from a sound generating device. By way of example the first surface may face away from the interior of an enclosed space, such as a sound isolation chamber, that includes a sound generating device. As such, the first surface may be a show surface. The first surface preferably has generally good aesthetics. The first surface preferably is a surface that does not easily scratch or mar so that it generally maintains its appearance over time. The first surface is preferably a surface of the reinforcing substrate layer.

The reinforcing substrate layer preferably provides stiffness and/or rigidity to the composite article, and provides sound attenuation at one or more frequencies. The foam layer preferably provides further sound attenuation, such as at a: frequency at which the reinforcing substrate layer provides insufficient sound attenuation. As discussed herein, the reinforcing substrate layer preferably provides stiffness and/or rigidity to the composite article, even at elevated temperatures to which the enclosed area or environment surrounding the enclosure will be exposed to. For example, the reinforcing substrate layer may provide stiffness and/or rigidity at about 90° C., at about 100° C., at about 120° C., at about 140° C., or at about 150° C.

The reinforcing substrate layer, the foam layer, or both preferably are ductile at low temperatures so that it can withstand impact without fracturing in a brittle mode. For example, the reinforcing substrate layer, the foam layer, or both may have a ductile to brittle transition temperature that is about 10° C. or less, preferably about −10° C. or less, more preferably about −20° C. or less, and most preferably about −30° C. or less. The reinforcing substrate layer, the foam layer, or both preferably has a ductile to brittle transition temperature of about −120° C. or more, more preferably about −60° C. or more.

The reinforcing substrate layer provides sufficient stiffness and/or rigidity to the composite article to maintain the composite article in a desired shape. Preferably the reinforcing substrate layer is light weight so that the composite article is generally light weight. As such, the reinforcing substrate layer preferably is made of materials which together produce a layer that is both rigid and light weight. It will be appreciated that the reinforcing substrate layer should maintain generally high stiffness and/or rigidity, over the range of temperatures to which the composite article may be exposed.

The reinforcing substrate layer is a solid that includes a polymer phase and a fiber phase. The polymer phase is preferably a continuous phase. The fiber phase may be a discrete phase dispersed in the polymer phase. The fibers may be uniformly dispersed in the polymer phase, or the concentration of fibers may vary in two or more different regions of the reinforcing substrate layer. Preferably, the fibers are uniformly dispersed in the polymer phase. For example, the variance in the concentration of fibers (as measured on 20 samples, each having an area of 1 cm²) may be less than 15%, less than about 10% or less than about 5% over at least 50% of the reinforcing substrate layer. The variance in the concentration of fibers may be measured on 20 random samples from a reinforcing substrate layer, each having an area of 1 cm². The fibers may have any orientation in the polymer phase. For example, the fibers may have a generally random orientation, may be generally axially aligned, may be generally aligned in a plane, or any combination thereof. The concentration of the fibers and the alignment of the fibers, if any, should be sufficient so the at fibers reinforce the polymer phase. As such, the reinforcing substrate layer including the fiber phase may have a relatively high heat distortion temperature, a relatively high elastic modulus, a relatively high flexural modulus, or any combination thereof, compared with the material of the polymer phase without the fibers. For example, the ratio of the flexural modulus (e.g., as measured according to ASTM D-790) of the reinforcing substrate layer to the flexural modulus of the polymer phase of the reinforcing substrate layer may be about 1.2 or more, about 2.0 or more, about 3.0 or more, or about 4.0 or more. The flexural modulus (e.g., as measured according to ASTM D-790) of the reinforcing substrate layer preferably is about 2000 MPa or more, more preferably about 4000 MPa or more, even more preferably about 6000 MPa or more, and most preferably about 8000 MPa or more.

Preferably, the reinforcing substrate layer is substantially free of voids (e.g., pores). For example, the reinforcing substrate layer may be generally non-porous. If voids are present, the concentration of voids preferably is sufficiently low so that the substrate is sufficiently rigid to support the weight of the sound panel. The concentration of voids, if present, may be about 25 volume percent or less, preferably about 10 volume percent or less, more preferably about 2 volume percent or less, even more preferably less than 1 volume percent, and most preferably about 0.5 volume percent or less, based on the total volume of the reinforcing substrate layer. It will be appreciated that the concentration of voids may be about 0.0 volume percent, or about 0.1 volume percent or more, based on the total volume of the reinforcing substrate layer.

The rigidity of the reinforcing substrate layer is surprisingly high, thus allowing for a reinforcing substrate layer that has generally low thickness. The thickness of the reinforcing substrate layer preferably is about 6.0 mm or less, more preferably about 5 mm or less, even more preferably about 4.5 mm or less, even more preferably about 4.0 mm or less, and most preferably about 3.5 mm or less. The reinforcing substrate layer preferably has a thickness of about 0.7 mm or more, more preferably about 1.5 mm or more, and most preferably about 2.0 mm or more.

The materials of the reinforcing substrate layer are selected so that the reinforcing substrate layer has a surprisingly low volume density, area density, or both. The volume density of the substrate layer is preferably about 1.50 g/cm³ or less, more preferably about 1.30 g/cm³ or less, even more preferably about 1.15 g/cm³ or less, and most preferably about 1.10 g/cm³ or less. The volume density of the reinforcing substrate layer is preferably about 0.7 g/cm³ or more, more preferably about 0.8 g/cm³ or more, even more preferably about 0.86 g/cm³ or more, and most preferably about 0.93 g/cm³ or more. The reinforcing substrate layer preferably has an area density of about 2000 g/m² or less, more preferably about 1750 g/m² or less, even more preferably about 1550 g/m² or less, even more preferably about 1450 g/m² or less, and most preferably about 1300 g/m² or less. The reinforcing substrate layer preferably has an area density of about 400 g/m² or more, more preferably about 600 g/m² or more, and most preferably about 800 g/m² or more.

The reinforcing substrate layer preferably includes a sufficient concentration of natural fibers so that the layer is rigid (e.g., has a flexural modulus of about 2000 MPa or more, about 4000 MPa or more, about 6000 MPa or more, or about 8000 MPa or more). The concentration of the natural fibers in the reinforcing substrate layer may be about 40 weight percent or more, more preferably about 50 weight percent or more, even more preferably about 60 weight percent or more, and most preferably about 65 weight percent or more. The concentration of the natural fibers in the reinforcing substrate layers preferably is about 90 weight percent or less. The concentration of the polymer phase in the reinforcing substrate layer may be about 60 weight percent or less, preferably about 50 weight percent or less, even more preferably about 35 weight percent or less, and most preferably about 30 weight percent or less. The concentration of the polymer phase in the reinforcing substrate layer preferably is about 10 weight percent or more, more preferably about 20 weight percent or more, even more preferably about 20 weight percent or more, and most preferably about 25 weight percent or more, based on the total weight of the reinforcing substrate layer. The reinforcing substrate layer preferably consists essentially of, or even entirely of the polymeric phase and the natural fibers. Preferably the total concentration of the polymeric phase and the natural fibers is about 70 weight percent or more, more preferably about 85 weight percent or more, even more preferably about 95 weight percent or more, even more preferably about 98 weight percent or more, and most preferably about 99.5 weight percent or more.

Although the composite panel may include a metallic layer (e.g., a layer of a metal or a metal alloy), the reinforcing substrate layer preferably is sufficiently stiff so that a layer of metallic layer is not required. As such the multi-layered composite panel may be substantially free, or entirely free of a metallic layer. For example, the multi-layered composite panel may be free of metallic layers having a thickness of about 0.1 mm or more, an area of about 0.3 m² or more, or both. If employed, a metallic layer preferably covers only a small portion of the area of the composite panel, such as about 40% or less, about 20% or less, about 10% or less, or about 5% or less. For example, a metallic layer may be employed in a stiffening region of the reinforcing substrate layer, may be attached to a portion (or the entirety) of a periphery of the reinforcing substrate layer, in a region of the reinforcing substrate layer that is fastened to a periphery of an opening, or any combination thereof. It will be appreciated that a metallic layer, if employed, may be used to provide structure, provide an aesthetic feature (such as a very thin metallic layer that may cover a portion or even the entirety of the reinforcing substrate layer) or both.

The fibers preferably are generally strong and light weight. For example, natural fibers may have both a desirably high tensile strength and a desirably high specific gravity so that the weight of the substrate can be reduced while maintaining a high stiffness.

The fibers may have a specific gravity of about 2.0 g/cm³ or less, preferably about 1.9 g/cm³ or less, more preferably about 1.8 g/cm³ or less, even more preferably about 1.7 g/cm³ or less, even more preferably about 1.6 g/cm³ or less, and most preferably about 1.5 g/cm³ or less. The fibers typically have a specific gravity of about 0.7 g/cm³ or more.

Natural fibers that may be employed in the substrate layer include animal fibers and vegetable fibers. Examples of vegetable fibers include seed fibers, leaf fibers, bast fibers (i.e., skin fibers), fruit fibers, and stalk fibers. Seed fibers include fibers from seeds and seed cases, such as cotton and kapok. Leaf fibers include fibers collected from leaves, such as agave, banana, fique, and sisal. Bast fibers include fibers collected from the bast or skin around the stem of a plant, such as flax, hemp, jute, kenaf, ramie, rattan, and vine fibers. Fruit fibers include fibers collected from the fruit of a plant, such as coconut fibers (i.e., coir fibers). Stalk fibers include fibers collected from the stalk of a plant such as bamboo stalks, barley stalks, straws of wheat, rice stalks, grass stalks, and tree wood. Preferred fibers include bast fibers. More preferred fibers include flax, hemp, flax, jute, ramie, rattan, or combinations thereof.

The natural fibers preferably are sufficiently hygroscopic so that they can provide water for curing the polymer, absorb residual water from the cured polymer (such as after a step of curing a polymer solution at a high temperature), or both. Hygroscopic fibers may be characterized as having a generally high water absorption, measured as percent increase in weight, after dry fibers are placed in water at about 25° C. for about 2 hours. The water absorption of the fibers preferably is about 5 weight percent or more, more preferably about 10 weight percent or more, even more preferably about 20 weight percent or more, and most preferably about 38 weight percent or more.

The natural fibers are preferably sufficiently long so that they provide reinforcement to the substrate layer. The natural fibers of the reinforcing substrate layer preferably includes or consists essentially of fibers that are sufficiently long so that they are entangled with one, two, three, four, or more other fibers. The weight average length of the natural fibers preferably is sufficiently long and sufficiently adheres to the polymeric phase so that the fibers do not readily pull out of the polymeric phase (e.g., when pulled in tensile). The weight average length of the natural fibers preferably is about 2 mm or more, more preferably about 10 mm or more, even more preferably about 15 mm or more, and most preferably about 25 mm or more. In particularly preferred aspects of the invention, the fibers may be very long, such as fibers having a length of about 53 mm or more, about 60 mm or more, about 75 mm or more, or about 100 mm or more. It will be appreciated that the fibers may be essentially continuous fibers, such as a woven fiber.

The natural fibers preferably are provided in a form suitable for combining with the polymer solution. For example, the natural fibers may be provided as a mass of fibers having a sufficient amount of pores so that the polymer solution can wet the surfaces of the fibers. The natural fibers may be provided as individual fibers, as groups of fibers, as a nonwoven material, as a woven material, or any combination thereof. The natural fibers may optionally be provided with other fibers that are not natural fibers, such as in a blend, a weave, a warp, or any combination thereof. Preferably the natural fibers are provided as a material without other fibers. More preferably, the natural fibers are provided as one or more sheets of fibers, woven, nonwoven, matted, or otherwise.

The fiber phase may be generally free of glass fibers and/or other generally dense fibers, so that the density of the reinforcing substrate layer is low. For example, the fiber phase may be generally free of dense fibers having a density of about 2.0 g/cm³ or more. If present, the concentration of dense fibers in the reinforcing substrate layer, in the composite sheet, or both, preferably is about 20 wt. % or less, about 10 wt. % or less, about 5 wt. % or less, or about 1 wt. % or less, based on the total weight of the fibers in the composite sheet and/or based on the total weight of the composite sheet.

The polymer phase of the reinforcing substrate layer includes one or more polymers that may function as a matrix for the fibers. The polymer phase preferably includes or consists essentially of one or more high temperature polymers. The one or more high temperature polymers preferably are capable of supporting a load even when a panel including the reinforcing substrate layer is used in an environment that has a high temperature, such as about 90° C., about 100° C., or about 120° C. The high temperature polymer may be characterized by a first or second order transition (such as a peak melting temperature, a glass transition temperature, or both) that is about 100° C. or more, preferably about 110° C. or more, more preferably about 120° C. or more, even more preferably about 125° C. or more, even most preferably about 130° C. or more, and most preferably about 150° C. or more. The high temperature polymer may be characterized by a by a first or second order transition (such as a peak melting temperature, a glass transition temperature, or both) that is about 280° C. or less, preferably about 210° C. or less, more preferably about 190° C. or less, and most preferably about 175° C. or less.

Polymers useful in the reinforcing substrate layer (i.e., polymers that serve as matrix) can be thermosetting polymers, thermoplastic polymers, or both. In one embodiment, the polymer may include, consist substantially of, or consist essentially of one or more thermosetting polymers. The thermosetting polymer may be a polymer that initially is a liquid at room temperature, so that it can easily flow into the spaces between the fibers, and upon cross linking or other thermosetting reaction the thermosetting polymer may develop a high glass transition temperature so that the substrate can be used in high temperature applications. As such, a particularly preferred substrate includes a polymer having a glass transition temperature of about 120° C. or more. Without being bound by theory, it is believed that the use of a thermosetting polymer according to the teaching herein results in a material having low free volume so that the reinforcing substrate layer has a stiffness greater than can be obtained using thermoplastic polymers (e.g., conventional thermoplastic polymers), while maintaining good ductility at low temperatures (e.g., at about 10° C., about 0° C., about −10° C., about −20° C., about −30° C. or any combination thereof). As such, the reinforcing substrate layer may be substantially free of (e.g., having a concentration of about 10 wt. % or less based on the total weight of the polymer of the reinforcing substrate layer), or entirely free of thermoplastic polymers. For example, the reinforcing substrate layer may be substantially free of or entirely free of thermoplastic polyethylene (e.g., thermoplastic homopolymers and copolymers include at least about 50 wt. % ethylene, such as HDPE, LLDPE, LDPE, MDPE, VLDPE, or any combination thereof), thermoplastic polypropylene (e.g., isotactic polypropylene or impact polypropylene copolymer), thermoplastic polyamides, thermoplastic polyesters, thermoplastic polystyrene, thermoplastic polycarbonate, or any combination thereof.

Preferred polymers for use in the polymer phase are polymers that are moisture curable. Moisture curable polymers either require water for curing, or have a cure rate in the presence of water that is substantially greater than the cure rate in a moisture free environment. For example, the ratio of the cure rate of the polymer in the presence of water (e.g., at a water concentration of about 5 weight % or more) to the cure rate of the polymer without water may be about 1.5 or more, about 2.0 or more, or about 3.0 or more.

Preferably the polymer phase includes, or consists essentially of one or more polymers having an ethylinically unsaturated acid monomer, one or more polymers including an acrylate monomer, one or more polymers including a styrene, or any combination thereof. The polymer having an ethylinically unsaturated acid monomer is preferably selected from an ethylinically unsaturated monocarboxylic acid, an ethylinically unsaturated dicarboxylic acid, an ethylinically unsaturated dicarboxylic anhydride, and any combination thereof. The polymer having an ethylinically unsaturated acid monomer may be a homopolymer, a copolymer, or both, and preferably includes, or consists essentially of a copolymer. The concentration of the ethylinically unsaturated acid monomer preferably is about 2 weight % or more, more preferably about 4 weight % or more, and most preferably about 5 weight % or more, based on the total weight of the polymer phase. A particularly preferred ethylinically unsaturated acid monomer is acrylic acid. For example, the polymer phase may include an acrylic acid copolymer. If employed, the acrylic acid copolymer preferably includes, or consists essentially of acrylic acid and styrene. The total concentration of acrylic acid and styrene in the acrylic acid containing copolymer preferably is about 50 weight or more, more preferably about 70 weight percent or more, more preferably about 90 weight percent or more, and most preferably about weight percent or more. The acrylic acid copolymer may contain maleic anhydride in addition to, or in place of the styrene. The acrylic acid copolymer may include one or more acrylate monomers in addition to or in place of the styrene. The copolymer may be a random copolymer, a block copolymer, an alternating copolymer, have an intermediate monomer arrangement thereof, or any combination thereof. Block copolymers may independently have one, two, three, four or more blocks of each monomer. The styrene containing polymer, if employed, may be a homopolymer or a copolymer. A particularly preferred styrene containing polymer is a copolymer including about 5 weight percent or more styrene. Preferred styrene containing polymers include copolymers having or consisting essentially of styrene and one or more acrylates. The total concentration of styrene and acrylate in the styrene containing copolymer preferably is about 40 weight percent or more, more preferably about 70 weight percent or more, even more preferably about 80 weight percent or more, and even more preferably about 90 weight percent or more, and most preferably about 95 weight percent or more, based on the total weight of the styrene containing copolymer. The styrene containing copolymer may be a random copolymer, a block copolymer, an alternating copolymer, have an intermediate monomer arrangement of a plurality thereof, or any combination thereof. Block copolymers may independently have one or preferably a plurality (e.g., one, two, three, four or more) of blocks of each monomer. The styrene containing copolymer includes one or more additional monomers or may be modified so that it can react with a cross-linking agent. The styrene containing copolymer may react with any cross-linking agent having, such as an amine cross-linking agent, a polyol cross-linking agent, and the like. Preferably, the styrene containing copolymer is modified with a carboxylic acid, or a polycarboxylic acid.

The polymer phase preferably is present in the reinforcing substrate layer at a sufficient concentration so that the polymer phase is a continuous phase. The concentration of the polymer phase preferably is about 10 weight percent or more, more preferably about 15 weight percent or more, even more preferably about 20 weight percent or more, and most preferably about 25 weight percent or more, based on the total weight of the reinforcing substrate layer. It will be appreciated that since the reinforcing substrate layer also includes a fiber phase, the concentration of the polymer phase will be less than 100%. The concentration of the polymer phase may be about 90 weight percent or less, preferably about 80 weight percent or less, more preferably about 70 weight percent or less, even more preferably about 60 weight percent or less, and most preferably about 50 weight percent or less, based on the total weight of the reinforcing substrate layer.

The polymer phase and the fiber phase may be a large portion of the reinforcing substrate layer. For example, the total concentration of the polymer phase and the fiber phase may be about 60 weight percent or more, preferably about 80 weight percent or more, more preferably about 90 weight percent or more, even more preferably about 97 weight percent or more, and most preferably about 99.5 weight percent or more, based on the total weight of the reinforcing substrate layer. It will be appreciated that the reinforcing substrate layer may consist essentially of the fiber phase and the polymer phase. As such the total concentration of the polymer phase and the fiber phase may be about 100 weight percent or less, or about 99.6 weight percent or less.

The polymer phase preferably wets and/or adheres to the fibers. When a composite including fibers and a polymer phase that does not wet or adhere to the fiber is fractured, the fibers may pull out of the polymer phase, the polymer phase may have generally low plastic deformation near the fibers, or both. Preferably the polymer phase wets and/or adheres to the fibers sufficiently so that upon fracturing, the fracture surface is generally free of fibers that have pulled out of the polymer phase, the polymer phase near the fibers have generally low evidence of plastic deformation (e.g., as determined by scanning electron microscopy of a fracture sample, such as a sample fractured at about 23° C. using ASTM D256), or both.

In the composite article, some, or essentially all of a polymer in the polymer phase of the reinforcing substrate layer may be cured and/or cross-linked. Preferably, a sufficient amount of polymer is cured and/or cross-linked so that a polymer network is created. As described herein, the polymer may be cured using one or more curatives, one or more cure accelerators, or both. The reinforcing substrate layer may include residual (i.e., unreacted) curative, or may be substantially free of residual curative. The reinforcing layer may include residual cure accelerator, or may be substantially free of residual cure accelerator.

The polymer phase may generally good high temperature heat resistance. Generally good high temperature heat resistance may be characterized by a retention of ultimate tensile strength, ultimate elongation, or both of about 50% or more, preferably about 80% or more, after aging for 336 hours at an elevated test temperature. The ultimate elongation and tensile strength may be measured according to ASTM D638, at a temperature of about 20° C. For example, the polymer phase may have generally good high temperature heat resistance at a test temperature of about 80° C., about 100° C., about 110° C., or about 120° C.

The reinforcing substrate layers may include one or more additives known to those of ordinary skill in the art. Preferred additives include one or more stabilizers, one or more flow modifiers, one or more process aids, one or more surfactants, one or more emulsifiers, one or more defoamers, or any combination thereof. Without limitation, the stabilizer may include a heat stabilizer, a light stabilizer, an antioxidant, an antiozonant, a flame retardant, or any combination thereof. Additional ingredients may be added to accelerate or retard a curing or cross-linking reaction at storage temperatures (i.e., before curing), at curing temperatures, or both. If employed, the flame retardant may include a halogenated flame retardant (e.g., a flame retardant including one or more halogens, such as bromine, chlorine, or both), a halogen free flame retardant, or both.

The reinforcing substrate may include one or more adhesion promoters for improving the adhesion between fibers and the polymer phase. Any adhesion promoter known in the art for adhering fibers and polymers may be employed. Preferred adhesion promoters include silanes and coupling agents (e.g., sizing agents). Without limitation, examples of adhesion promoters include those described by J. L. O'Dell, “Natural Fibers in Resin Transfer Molded Composites”, The Fourth International Conference on Woodfiber-Plastic Composites, The Forest Products Society: Proceedings No. 7277, pages 280-285, 1997, incorporated herein by reference in its entirety. The reinforcing substrate may employ a fiber and a polymer phase having good adhesion without the use of an adhesion promoter. In preferred aspects of the invention, the reinforcing substrate and/or the composite article is substantially free of fibers that have been treated with a silane and/or a coupling agent for promoting adhesion between the polymer and the fibers. As such, preferred reinforcing substrates may be substantially free of, or entirely free of silanes and/or coupling agents.

The reinforcing substrate layer may include one or more colorants, one or more pigments, one or more dyes, or any combination thereof. In a particularly preferred embodiment of the invention the reinforcing substrate layer includes a sufficient quantity of colorant, pigment, and/or dye so that the reinforcing substrate layer has a predetermined color. For example, the reinforcing substrate layer may include one or more colorants, pigments, or dyes other than carbon black. As such, the reinforcing substrate layer may advantageously be used for producing a composite article that is visible outside of a sound isolation chamber. The colorant, pigment and/or dye may be included in the natural fibers, in the polymer phase, or both. Preferably the colorant, pigment and/or dye is included at least in the polymer phase. If a colorant, pigment and/or dye is included in the reinforcing substrate layer, the substrate layer preferably includes one or more light stabilizers, such as one or more UV light stabilizers.

The composite article may be employed in an application requiring low flammability. As such, the reinforcing substrate layer may include one or more flame retardants, so that the flame retardancy of the article is improved. If employed, the flame retardant may be used in the foam layer, the reinforcing substrate layer, or both. Preferably, the flame retardant is present at a sufficient quantity in the foam layer, the reinforcing substrate layer, or both, so that the foam layer, the reinforcing layer, or the composite article, or any combination thereof passes FMVSS 302 class B for flammability. More preferably, the flame retardant is present at a sufficient quantity in the foam layer, the reinforcing substrate layer, or both, so that the foam layer, the reinforcing layer, or the composite article, or any combination thereof passes FMVSS 302 class A for flammability. The flame retardant may include, consist substantially of, or consist entirely of a halogen containing compound, antimony oxide, a phosphorous-containing flame retardant, a metal salt of a sulfonic acid, antimony oxide, aluminum trihydrate, magnesium hydroxide, a silicon-based flame retardant, or any combination thereof. Exemplary flame retardants that may be employed alone or in combination include flame retardants disclosed in U.S. Pat. Nos. 3,535,300, 3,775,367, 3,971,756, 4,883,835, 4,983,658, 5,061,745, and 6,001,921, incorporated herein by reference.

The reinforcing substrate layer preferably reduces the transmission of sound, e.g., sound having one or more frequencies from about 20 Hz to about 20 kHz. The reduction in sound transmission of sound having a first frequency between 20 Hz and 20 kHz may be about 1 dB or more, about 2 dB or more, about 5 dB or more, about 10 dB or more, or about 15 dB or more. It will be appreciated that the reinforcing substrate layer may be less efficient at reducing sound having a second frequency between 20 Hz and 20 KHz (e.g., compared to the reduction in sound transmission of the sound having the first frequency. For example, the reinforcing substrate layer may reducing the transmission of sound having a first frequency by 1 dB or more, and reduce the transmission of sound having the second frequency by 1 dB or less. As another example, the reinforcing substrate layer may reducing the transmission of sound having a first frequency by 5 dB or more, and reduce the transmission of sound having the second frequency by 5 dB or less.

The reinforcing substrate layer and the foam layer may have frequency tuned sound reduction. The foam layer may be any foamed material that is capable of reducing the transmission of sound. The foam layer preferably has a large concentration of voids, so that the sound is not easily transmitted. As such, the foam layer has a generally low density. So that the sound is not easily transmitted, the foam layer preferably has a density of about 0.8 g/cm³ or less, more preferably about 0.7 g/cm³ or less, even more preferably about 0.6 g/cm³ or less, even more preferably about 0.5 g/cm³ or less, and most preferably about 0.4 g/cm³ or less. The foam layer preferably has a density of about 0.08 g/cm³ or more, however, foams having a lower density may be used.

The foam layer preferably has a first surface for disposing onto the reinforcing substrate layer and a second opposing surface for facing a sound generating device (e.g., a sound generating device inside a sound isolation chamber). As discussed hereinbefore, the second surface preferably is an arcuate surface so that the total surface area of the second surface is greater than the first surface. Without intending to being bound by theory, it is believed that a non planar surface of a foam layer provides for increased sound absorption, reduced sound reflection, or both. The ratio of the total area of the second surface of the foam layer to the total surface area of the first surface of the foam layer preferably is about 1.1 or more, more preferably about 1.2 or more, even more preferably about 1.3 or more, and most preferably about 1.4 or more.

The foam layer may be made from a thermoset polymer composition, a thermoplastic polymer composition, or any combination thereof. The foam may have an open cell structure, a closed cell structure, or a structure that includes open cells and closed cells. The materials for the foam layer may be selected so that the foam layer efficiently attenuates sound (e.g., by absorption, reflection, or both). A preferred foam that may be used is a reticulated foam.

The foam layer preferably reduces the transmission of sound, e.g., sound having one or more frequencies from about 20 Hz to about 20 kHz. The reduction in sound transmission may be measured at about 20 Hz, about 100 Hz, about 125 Hz, about 160 Hz, about 200 Hz, about 250 Hz, about 315 Hz, about 400 Hz, about 500 Hz, about 630 Hz, about 800 Hz, about 1000 Hz, about 1250 Hz, about 1600 Hz, about 2000 Hz, about 2500 Hz, about 3150 Hz, about 4000 Hz, about 5000 Hz, about 7000 Hz, about 10000 Hz, about 15000 Hz, about 20000 Hz, or any combination thereof. The reduction in sound transmission may be about 1 dB or more, about 2 dB or more, about 5 dB or more, about 10 dB or more, or about 15 dB or more. The reduction in sound transmission may be about 80 dB or less, however higher values may be achieved. For example, the reduction in sound transmission may be about 80 dB or more).

The foam layer may be less efficient at reducing sound having a second frequency between 20 Hz and 20 KHz compared with its ability to reduce the transmission of sound at a first frequency. For example, the foam layer may reduce the transmission of sound having a first frequency by 1 dB or more, and reduce the transmission of sound having the second frequency by 1 dB or less. As another example, the foam layer may reduce the transmission of sound having a first frequency by 5 dB or more, and reduce the transmission of sound having the second frequency by 5 dB or less. By way of example, the first frequency may be about 800 Hz or more (e.g., about 1000 Hz or more, about 1250 Hz or more, about 1600 Hz or more, about 2000 Hz, or about 4000 Hz or more) and the second frequency may be about 500 Hz or less (e.g., about 400 Hz or less, about 250 Hz or less, or about 200 Hz or less).

The foam layer should be sufficiently thick so that it reduces transmission of sound. The thickness of the foam layer is preferably about 1 mm or more, more preferably about 2 mm or more, and most preferably about 3 mm or more. The thickness of the foam layer is preferably about 12 mm or less, more preferably about 8 mm or less, and most preferably about 6 mm or less. However thicker foam layers may be employed. The foam layer should not be too thick that it poses a risk of being damaged by mechanical movement of a device (such as a device inside a sound isolation chamber) and/or that it contacts a surface heated to a temperature sufficiently high that it can degrade the foam.

The foam layer preferably has a generally high sound absorption coefficient, a generally high noise reduction coefficient (i.e., NRC), or both, as measured according to ASTM Standard Test Method C423-90a “Standard Test Method for Sound Absorption and Sound Absorption coefficients by the Reverberation Room Method,” at one or more frequencies from about 20 Hz to about 20000 Hz. For determining the sound absorption coefficient, the frequency is preferably the ⅓ octave center frequency. Preferably the test samples are prepared according to ASTM E795-93 “Standard Practices for Mounting Test Specimens during Sound Absorption Tests.” For example, the test may be performed on a specimen having a length of about 2.74 m, a width of about 2.44 m and a thickness of about 25 mm. The test may be performed in a chamber having a volume of about 292 m³. The test may be performed at room temperature (e.g., about 22° C.), a relative humidity from about 40% to about 80% (e.g., about 58%), or both. The sound absorption coefficient of the foam layer preferably is about 0.5 or more, more preferably about 0.6 or more, more preferably about 0.7 or more, even more preferably about 0.8 or more, and most preferably about 0.9 or more, at one or more frequencies from about 20 Hz to about 20000 Hz. Preferably, the sound absorption coefficient of the foam layer is about 0.5 or more at one or more higher sound frequencies (e.g., at a frequency of about 630 Hz or more, about 800 Hz or more, about 1000 Hz or more, about 1250 Hz or more, about 1600 Hz or more, about 2000 Hz or more, about 2500 Hz or more, about 3150 Hz or more, about 4000 Hz or more, about 5000 Hz or more, about 7000 Hz or more, about 10000 Hz or more, about 15000 Hz or more, about 20000 Hz, or any combination thereof). For example, the sound absorption coefficient of the foam layer may be about 0.5 or more, or about 0.6 or more when measured at frequencies from about 630 Hz to about 5,000 Hz. Preferably the sound absorption coefficient of the foam lay may be about 0.75 or more, or about 0.84 or more when measured at frequencies from about 1000 Hz to about 5,000 Hz. The foam layer may have a relatively low sound absorption coefficient at one or more lower sound frequencies (e.g., at a sound frequency of about 500 Hz or less, about 400 Hz or less, about 315 Hz or less, about 250 Hz or less, about 160 Hz or less, about 125 Hz or less, or about 100 Hz or less, or any combination thereof), such that the sound absorption coefficient at one or more lower sound frequencies is less than the sound absorption coefficient at one or more higher sound frequencies. By way of example, the sound absorption coefficient of the foam layer may be about 0.5 or less (e.g., about 0.2 or less) at a low sound frequency (e.g., about 200 Hz) and the sound absorption coefficient of the foam layer may be about 0.5 or more (e.g. about 0.8 or more, or about 0.9 or more) at a high sound frequency (e.g., about 1250 Hz, or about 2000 Hz). The foam layer preferably has an NRC of about 0.2 or more, more preferably about 0.3 or more, even more preferably about 0.4, and most preferably about 0.5 or more (e.g., about 0.6). The foam layer preferably has an NRC of about 1.0 or less (e.g., about 0.95 or less, about 0.90 or less, about 0.80 or less, or about 0.7 or less).

The foam layer preferably is selected so that it complements the sound transmission properties of the reinforcing substrate layer. For example, the foam layer preferably is more efficient than the reinforcing substrate layer at reducing the sound transmission for sound having one frequency between 20 Hz and 20 KHz (e.g., about 20 Hz, about 100 Hz, about 125 Hz, about 160 Hz, about 200 Hz, about 250 Hz, about 315 Hz, about 400 Hz, about 500 Hz, about 630 Hz, about 800 Hz, about 1000 Hz, about 1250 Hz, about 1600 Hz, about 2000 Hz, about 2500 Hz, about 3150 Hz, about 4000 Hz, about 5000 Hz, about 7000 Hz, about 10000 Hz, about 15000 Hz, about 20000 Hz, or any combination thereof), and the reinforcing substrate layer is more efficient than the foam layer at reducing the sound transmission for sound have a different frequency between 20 Hz and 20 kHz.

The reinforcing substrate layer may be prepared using a process that includes a step of providing the one or more polymers, a step of providing the fibers (e.g., a mat of fibers) and a step of wetting or impregnating the fibers with at least the polymer. Preferably, the process includes a step of providing the polymer in a form capable of flowing through a mat of fibers and wetting the fibers.

The one or more polymers may be provided as a solid polymer, a polymer melt, a polymer solution, or any combination thereof. Preferably the one or more polymers are provided as a polymer solution including one or more liquids. As used herein, the term polymer solution includes polymers dissolved in one or more solvents and polymers in an emulsion. In a particularly preferred aspect of the invention, the one or more polymers are provided as an emulsion in water. For example, the concentration of the one or more polymers in the emulsion, the solids content of the emulsion, or both, is preferably about 15 weight percent or more, more preferably about 25 weight percent or more, and most preferably about 35 weight percent or more, based on the total weight of the emulsion. The solids concentration of the polymers in the emulsion, the solids content of the emulsion, or both, preferably is about 80 weight percent or less, more preferably about 70 weight percent or less, and most preferably about 60 weight percent or less. The water concentration of the emulsion may be about 20 weight percent or more, more preferably about 30 weight percent or more, and most preferably about 40 weight percent or more. The concentration of water in the emulsion preferably is about 85 weight percent or less, more preferably about 75 weight percent or less, and most preferably about 65 weight percent or less. The emulsion may include an emulsifier, a defoamer, a surfactant, or any combination thereof. The emulsion preferably includes one or more curatives, one or more cure accelerators, one or more cure retarders, or any combination thereof. If the emulsion includes a curative, the curative preferably does not cause the polymer to significantly cross-link during storage. For example, the curative may be physically isolated from the polymer, the curative may be capped or otherwise deactivated, the curative may require an initiator and/or an accelerator that is physically isolated from the polymer, the curative or both, the cure rate may be generally low at storage temperatures (e.g., at about 25° C.), or any combination thereof. Preferably the polymer solution is a 1 component, shelf stable solution. A particularly preferred curative is a polyol. The process may include a step of adding one or more stabilizers, such as one or more flame retardants, to the polymer and/or to the emulsion.

The polymer solution preferably is prepared before contacting the polymer with the fibers. Suitable polymer solutions are commercially available for example as aqueous dispersions of a polycarboxylic acid and/or styrene-acrylic polymer modified with a polycarboxylic acid and a polyol as crosslinking component, such as ACRODUR® from BASF Company, Ludwigshafen, Germany. Preferred grades include styrene-acrylic polymer ACRODUR® DS 3515 characterized by a solids content of about 50 weight percent, a pH of about 3.5 and a viscosity of about 150-300 mPa·s; ACRODUR® DS 3530 characterized by solids content of about 50 weight percent, a pH of about 3.5 and a viscosity of about 150-300 mPas; ACRODUR® DS 3558 characterized by a solids content of about 50 weight percent, a pH of about 3.5 and a viscosity of about 300-1500 mPa·s; and ACRODUR® 950L characterized by a solids content of about 50 weight percent, a pH of about 3.5 and a viscosity of about 900-2500 mPa·s.

The process for preparing the composite article may includes a step of impregnating the fibers with the flowable polymer. For example, a mat of natural fibers may be impregnated by the polymer or polymer solution. Preferably the natural fibers (e.g., the mat of natural fibers includes a sufficient amount of open spaces, and the polymer solution includes a sufficient amount of water so that the polymer solution can flow into the open spaces (e.g. to form an impregnated mat).

The process for preparing the composite article may include a step of partially drying the impregnated natural fibers (e.g. the impregnated mat) to form partially dried impregnated natural fibers. Drying the impregnated natural fibers may reduce the water concentration of the impregnated fibers, partially cure the polymer, or both. The partially dried impregnated natural fibers (e.g., the partially dried impregnated mat) preferably is sufficiently dried to reduce the water concentration and/or partially cure the polymer so that it can be handled as a solid, so that the polymer does not flow out of the fibers, or both.

The concentration of water in the partially dried impregnated fibers is preferably about 4 weight percent or more, more preferably about 7 weight percent or more, even more preferably about 10 weight percent or more, and most preferably about 15 weight percent or more, based on the total weight of the water and the one or more polymers. The concentration of water in the partially dried impregnated fibers is preferably about 30 weight percent or less, more preferably about 25 weight percent or less, even more preferably about 23 weight percent or less, and most preferably about 13 weight percent or less, based on the total weight of the water and the one or more polymers. The concentration of water in the partially dried impregnated fibers preferably is sufficiently high so that the polymer can be cured to a higher level of cure, so that the polymer can be cured at lower temperatures, or both.

The process for preparing the composite article may include a step of curing the polymer in a mold under pressure and at a sufficiently high curing time and curing temperature so that the polymer stiffens and/or the polymer no longer flows. The curing time and curing temperature may be sufficient so that the polymer phase achieves a glass transition temperature of about 100° C. or more, preferably about 110° C. or more, even more preferably about 120° C. or more, and most preferably about 130° C. or more. As the polymer phase cures, the impregnated fibers become a reinforcing substrate. The mold preferably is a vented mold so that water can be removed. The curing temperature preferably is about 130° C. or more, more preferably about 150° C. or more, even more preferably about 170° C. or more, even more preferably about 190° C. or more, and most preferably about 205° C. or more.

The difference in the concentration of water in the impregnated fibers before the high temperature curing step in the mold and the concentration of water in the impregnated fibers after the high temperature curing step in the mold, is preferably about 7 weight percent or more, more preferably about 10 weight percent or more, even more preferably about 12 weight percent or more, and most preferably about 15 weight percent or more, based on the total weight of the water and the one or more polymers of the polymer solution.

The process may include one or more steps of shaping the impregnated fibers, the partially dried impregnated fibers, or both. Preferably, the process includes a step of shaping the partially dried impregnated fibers in the mold during the high temperature curing step.

The process may include a step of arranging the partially dried impregnated fibers, the aesthetic layer, and any optional layer of the composite article into a stack of layers; placing the stack of layers into a mold; and molding the stack of layers, wherein the molding step includes forming the article in the mold, curing the partially dried impregnated fibers in the mold to form the reinforcing substrate layers, and adhesively joining each pair of adjacent layers in the mold. As such, the process may be a one-step process in that all of the layers are formed and joined in one molding step. Thus, the process may advantageously be free a step of joining two or more layers together after the molding step and/or joining two or more layers together before the molding step. In other words, the process may require few joining steps, or even require no joining steps other than the joining of the layers during the molding step.

Surprisingly, the generally high water concentrations of the partially dried impregnated fibers allows for short molding times, despite the need to remove additional moisture from the composite article during the molding step. For example the molding cycle time may be reduced by about 5% or more, more preferably by about 10% or more, and most preferably by about 15% or more compared with an identical process using the same material except the partially dried impregnated fibers are replaced with nearly completely dried impregnated fibers having a water concentration of about 5 weight percent or less, based on the total weight of the water and the polymer.

The selection of materials and the use of the partially dried impregnated natural fibers results in materials having reduced weight, improved rigidity, particularly at high temperatures, and more efficient manufacturing process, in that shorter cycle times are attained and that few joining steps are required.

The molding process may be a batch process or a continuous process. In a batch process, the layers may be cut into a suitable length and width for placing in a mold. In a continuous process, one or more of the layers may be continuously fed into a mold.

The molding process preferably includes a step of molding a texture onto one or more surfaces of the reinforcing substrate layer, molding a design (e.g., such as a design that includes a text, a logo, or other picture) onto one or more surfaces of the reinforcing substrate layer, molding one or more ribs, molding one or more elongated edges, molding one region that is thicker than another regions, or any combination thereof.

The process preferably includes one or more steps of attaching or otherwise disposing the foam layer on the reinforcing substrate layer. The foam layer preferably is attached to the reinforcing substrate layer by heat bonding the two layers, by applying an adhesive to the foam layer (e.g., between the foam layer and the reinforcing substrate layer), or both. If an adhesive is employed, any art known adhesive may be used. Preferred adhesives are adhesives that are substantially free of, or entirely free of solvent and/or other volatiles. For example the concentration of solvents and other volatiles in the adhesive preferably is about 10 wt. % or less, more preferably about 2 wt. % or less, and most preferably about 1 wt. % or less, based on the total weigh of the adhesive.

The composite article preferably has a low area density so that the composite is generally light weight. The area density of the composite article preferably is about 2,500 g/m² or less, more preferably about 1,700 g/m² or less, even more preferably about 1,500 g/m² or less, even more preferably about 1,400 g/m² or less, and most preferably about 1,350 g/m² or less. The composite article may have an area density of about 600 g/m² or more.

The area density of a material in sheet form is determined by measuring the mass of 1 square meter of the sheet. The area density may be expressed in units of g/m². The volume density of a material is the mass of 1 cm³ of material. The volume density may be expressed in units of g/cm³.

The composite article reduces sound transmission of sound having one or more frequencies in the range of 20 Hz to about 20 KHz preferably by about 10 dB or more, more preferably by about 15 dB or more, and most preferably by about 20 dB or more. More preferably the composite article reduces sound transmission of sound over a range of frequencies. For example the composite article may reduce sound transmission over a range of frequencies (e.g., from about 20 Hz to about 200 Hz, from about 200 Hz to about 2 kHz, from about 2 kHz to about 20 kHz, or any combination thereof) by about 10 dB or more, preferably by about 15 dB or more, and more preferably by about 20 dB or more.

The composite article preferably has good flame resistance properties. For example, the reinforcing substrate layer, the foam layer, the composite article or any combination thereof may pass FMVSS-302 burn specifications for E84 Class C, E84 Class B, or E84 Class A. Preferred reinforcing substrate layers, foam layers, and composite articles are capable of passing one or more burn tests disclosed in Cal 117 and UL94 burn specifications.

The composite article preferably is resistant to distortion when exposed to high temperatures, high humidity, or both. For example, the composite article preferably is capable of being exposed to a humidity of about 97% for 24 hours at a temperature of about 20° C., about 50° C., about 100° C., about 120° C., about 150° C., or any combination thereof without significantly distorting. As used herein, significant distortion is a distortion of about 1% or more, about 2% or more, or about 4% or more.

The composite article according to the teachings herein may be employed as an access panel, and preferably as an access panel for covering an opening sufficiently large so that a person can pass through the opening. As such, it is contemplated the composite article, the reinforcing substrate layer, the foam layer, or any combination thereof, may have a length of about 0.6 m or more, about 1.8 m or more, about 1.0 m or more, about 1.2 m or more, or about 1.4 m or more. It is also contemplated that such a composite article, reinforcing substrate layer, foam layer, or any combination thereof, may have a width of about 0.3 m or more, about 0.4 m or more, about 0.5 m or more, about 0.6 m or more, or about 0.7 m or more.

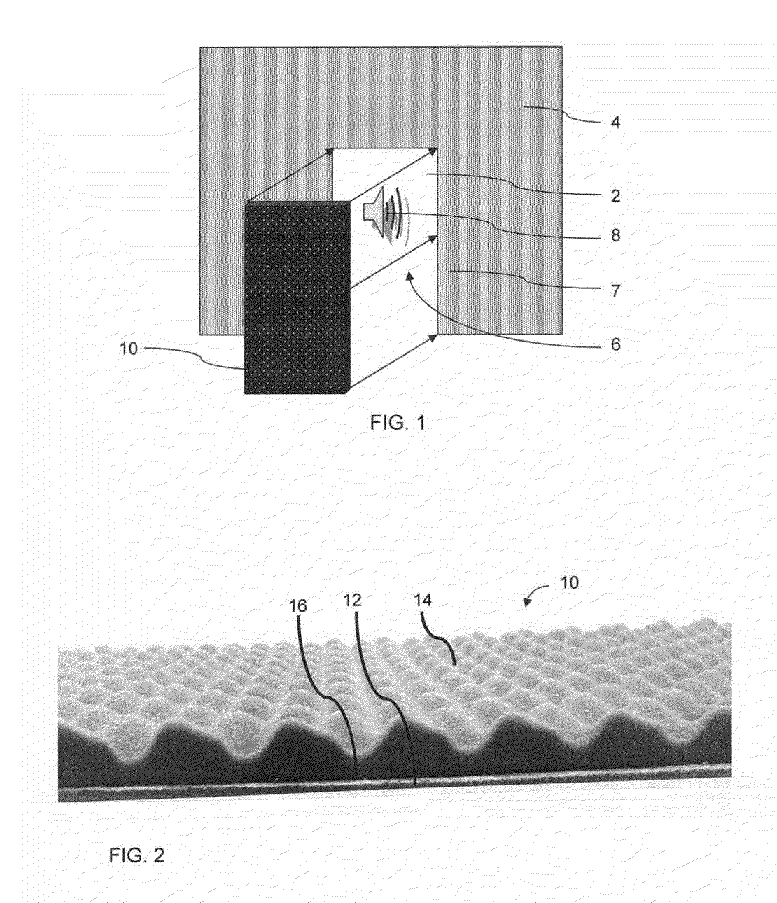

The composite article may be configured as a panel, such as a panel that is sufficiently rigid to be self-supporting. With reference to FIG. 1, the composite article 10 may be used to close or otherwise cover an opening 2 to a wall or chamber 4. The chamber may be a sound isolation chamber. For example, the chamber may include a sound or sound source 8 in the inside of the chamber 6. The composite article 10 may be used in a process including a step of covering (e.g., entirely covering) the opening 2 with the composite article 10 so that the level of the sound (e.g., the sound from a sound source 8 inside the chamber 6) observed in a region outside the chamber 7 is substantially reduced. It will be appreciated that the composite articles according to the teachings herein may also be used in other applications that will take advantage of one or more of the aforementioned characteristics. The sound isolation chamber generally includes one or more sound generating devices or machines. The sound isolation chamber preferably functions to reduce the level of noise outside 7 of the chamber compared to the level of noise inside 6 the chamber. As such, the composite article 10 may reduce or substantially eliminate the transmission of sound through the region of the opening 2. The composite article preferably functions as an access panel so that an individual may access the interior 6 of the sound isolation chamber 4. One or more noise generating sources 8 may be located within the sound isolation chamber.

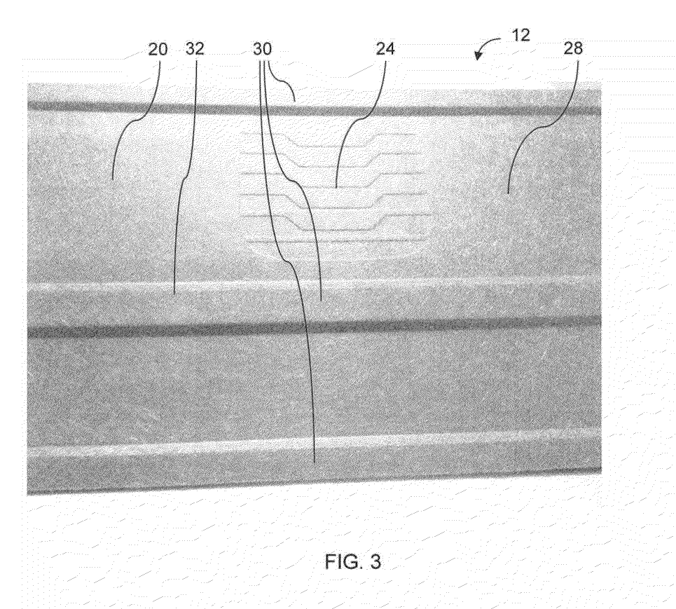

An illustrative composite article according to the teachings herein is shown in FIG. 2. The composite article 10 includes a reinforcing substrate layer 12 and a foam layer 14 disposed thereon. The foam layer may disposed over a portion of, or even all of a surface of the reinforcing substrate layer. Preferably, the foam layer is disposed over substantially all of a surface of the reinforcing layer. The foam layer 14 may be disposed on a side of the reinforcing substrate layer that is intended to face towards (e.g., actually faces towards) the interior of the sound isolation chamber, on a side of the reinforcing substrate layer that is intended to face away from (e.g. actually faces away from) the interior of a sound isolation chamber, or both. Preferably, the composite article 10 includes a foam layer 14 disposed on a surface of the reinforcing substrate layer 12 that is intended to face towards the interior 6 of a sound isolation chamber 4. Preferably, the composite article 10 does not include a foam layer disposed on a surface of the reinforcing substrate layer 12 that is intended to face away from the interior of the sound isolation chamber 4, so that one or more features of the surface of the reinforcing substrate layer is visible from outside the sound isolation chamber 4. The foam layer 14 may have one or more surfaces that is generally planar. The foam layer 14 may have one or more surfaces that is generally nonplanar (e.g., generally arcuate).

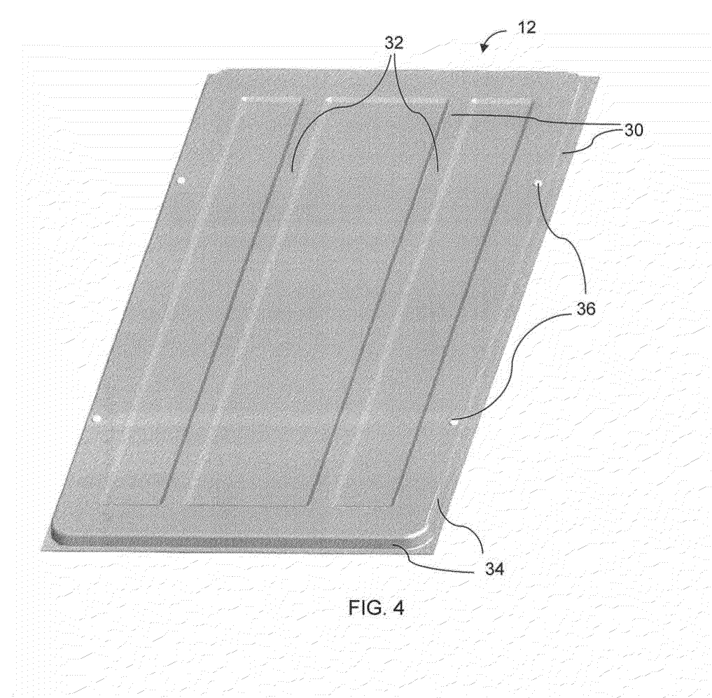

FIG. 3 illustrates a front view of a reinforcing substrate layer 12 according to the teachings herein. The reinforcing substrate layer may have a front side 20 (e.g., a surface of the front side) that is intended to face away from the interior of the sound isolation chamber 4. The front side 20 of the reinforcing substrate layer 12 preferably includes one or more features that are visible (e.g., that are visible on the composite article). For example, the front side 20 of the reinforcing substrate layer 12 may include one or more embossed regions 24 (e.g., an embossed region that is formed during a step of molding the reinforcing substrate layer), one or more textures 26 (e.g., a texture that is formed during a step of molding the reinforcing substrate layer), one or more molded-in colors 28, or any combination thereof. With reference to FIG. 3, the reinforcing substrate layer preferably includes one or more structural features 30, such as a structural feature that increases the rigidity of the reinforcing substrate layer. For example, the reinforcing substrate layer may include one or more ribs 32, one or more regions having increased thickness, one or more elongated edges 34, one or more beam sections, one or more locally raised sections, or any combination thereof.

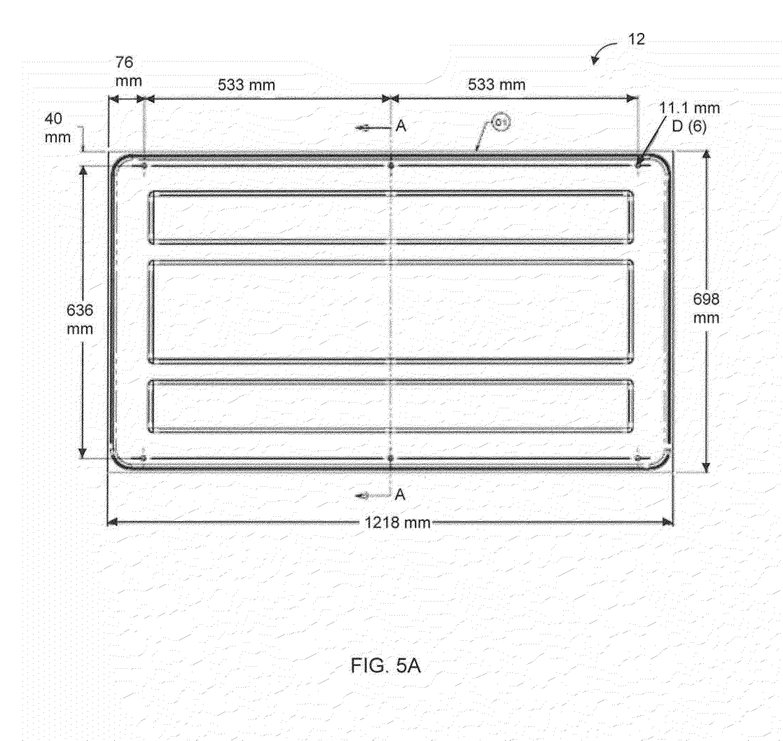

FIG. 4 is a schematic drawing of an illustrative reinforcing substrate layer. The reinforcing substrate layer 12 may include one or more features for attaching the reinforcing substrate layer to a frame or another panel of a sound isolation chamber 4. For example, the reinforcing substrate layer may include one or more attachment openings 36, such as an opening suitable for accommodating a screw, bolt, nail, or other fastener.

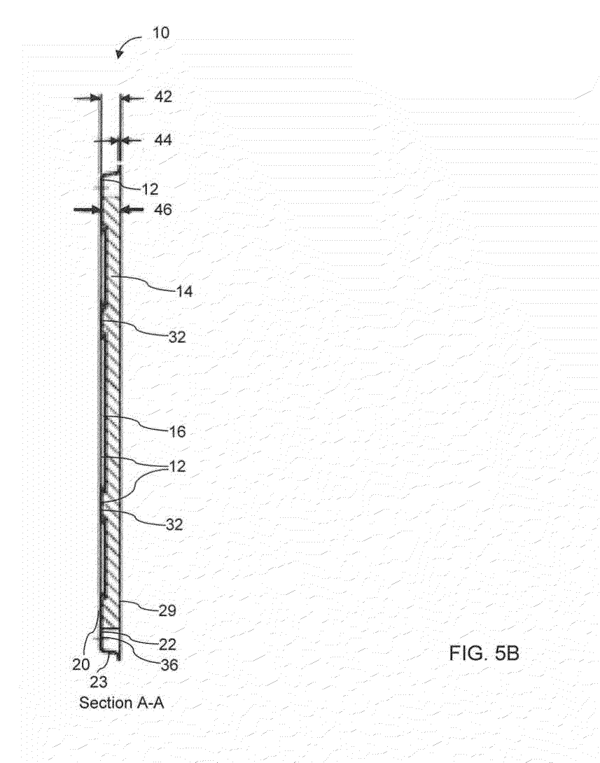

FIGS. 5A, 5B, 5C, 5D, 5E and 5F are projections illustrating features of composite article, and components of the composite article that may be employed according to the teachings herein. An illustrative front surface 20 of a reinforcing substrate layer 12 is shown in FIG. 5A. As illustrated in FIG. 5A, the reinforcing substrate layer may be capable of cover an opening that is sufficiently large that a person can easily pass through. The reinforcing substrate layer preferably has one or more holes of sufficient size and number so that the reinforcing substrate layer 12 can be attached to a periphery of the opening 2 (e.g., attached to a frame at the periphery of the opening). The cross-section of the composite article 10 of FIG. 5A taken through points A-A is shown in FIG. 5B. In FIG. 5B, a foam layer 14, and an optional adhesive layer 16 is seen, in addition to the reinforcing substrate layer 12. As illustrated in FIG. 5B, the depth 42 of the reinforcing substrate layer 12 may be greater than the thickness 44 (e.g., the wall thickness) of the reinforcing substrate layer 12. The reinforcing substrate layer 12 may have a generally uniform thickness or may have a thickness that varies. For example, the reinforcing substrate layer may include a region that has a thickness that is about 50% or more greater than the average thickness of the reinforcing substrate layer. Preferably the reinforcing substrate layer 12 has at least one depth 42 that is about 50% or more greater than the average wall thickness, at least one region that has a wall thickness about 50% or more greater than the average wall thickness, or both. The reinforcing substrate layer may have an edge surface 23, such as along one or more of (e.g., all of) the edges of the reinforcing substrate layer. As such, the reinforcing substrate layer may have a generally tray like shape. The reinforcing substrate layer may have a shape suitable for accommodating a foam layer (e.g., so that the foam layer 14 is generally maintained within the space defined by the boundaries of the reinforcing substrate layer 12. Preferably, the thickness of the foam layer (e.g., the maximum thickness of the foam layer) 46 is equal to, or less than the depth 42 of the reinforcing substrate layer 12. For example, the depth 42 of the reinforcing substrate layer 12 and the thickness of the article 10 may be the same. The adhesive layer 16, if employed, may be interposed between the foam layer 14 and the reinforcing substrate layer 12. The rear surface 29 of the article 10 (e.g., the panel) may be adapted for facing the interior of a chamber including a sound source. As such, the rear surface 29 of the article may include or consist substantially of the foam layer 14. With reference to FIG. 5B, a minor portion of the rear surface of the reinforcing substrate layer 22 may be visible, such as in a region near the outer periphery of the article. Features of the rear surface 29 projection of a panel of FIG. 5B is illustrated in FIG. 5C. Projections of an illustrative foam layer are shown in FIGS. 5D, 5E, and 5F. The foam layer may have a generally planar surface so that the foam layer can easily be attached to a reinforcing substrate layer 12 (e.g., a generally planar section of a reinforcing substrate layer). The foam layer may have a generally arcuate (e.g., convoluted) surface so that the foam layer can efficiently absorb sound. The foam layer may have a minimum thickness and a maximum thickness, wherein the ratio of the minimum thickness to the maximum thickness is about 1.0 or less, about 0.95 or less, about 0.85 or less, about 0.7 or less, about 0.6 or less, or about 0.5 or less. FIG. 5.

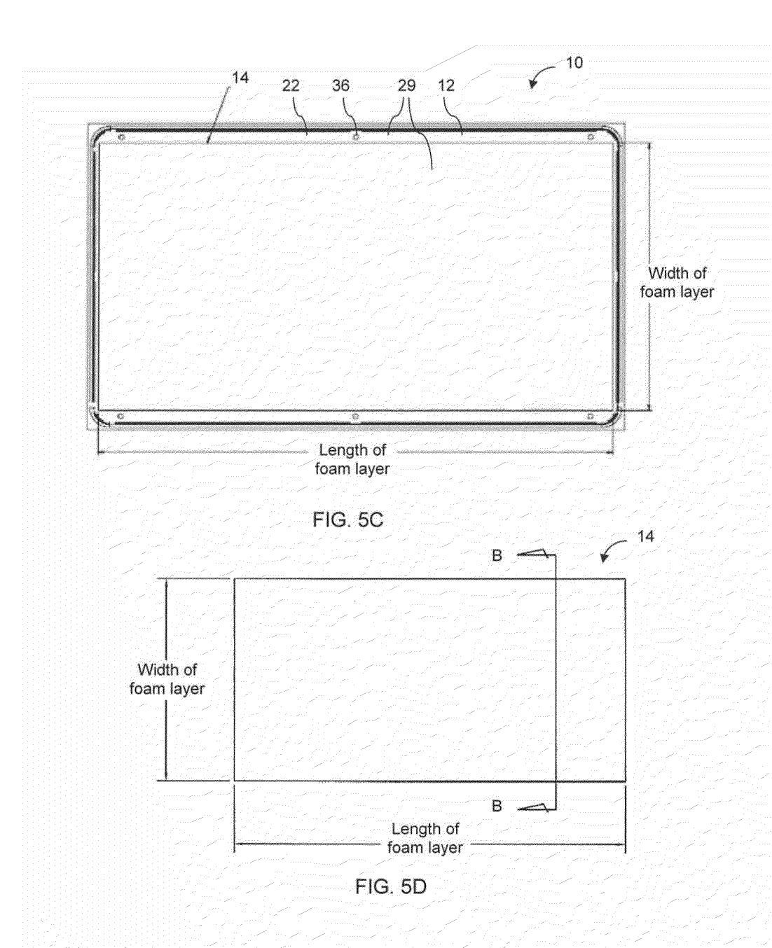

A section of a foam layer 14 having a convoluted surface that may be used according to the teachings herein is illustrated in FIG. 6A. The convoluted surface may include a plurality of relatively thick points, such as a peak 64, and a plurality of relatively thin points, such as a valley 65. Another section of a foam 14 having peaks 64 and valleys 65 is illustrated in FIG. 6B. With reference to FIG. 6B, the foam 14 may include a plurality of (e.g., a pattern of) pyramid shaped regions.

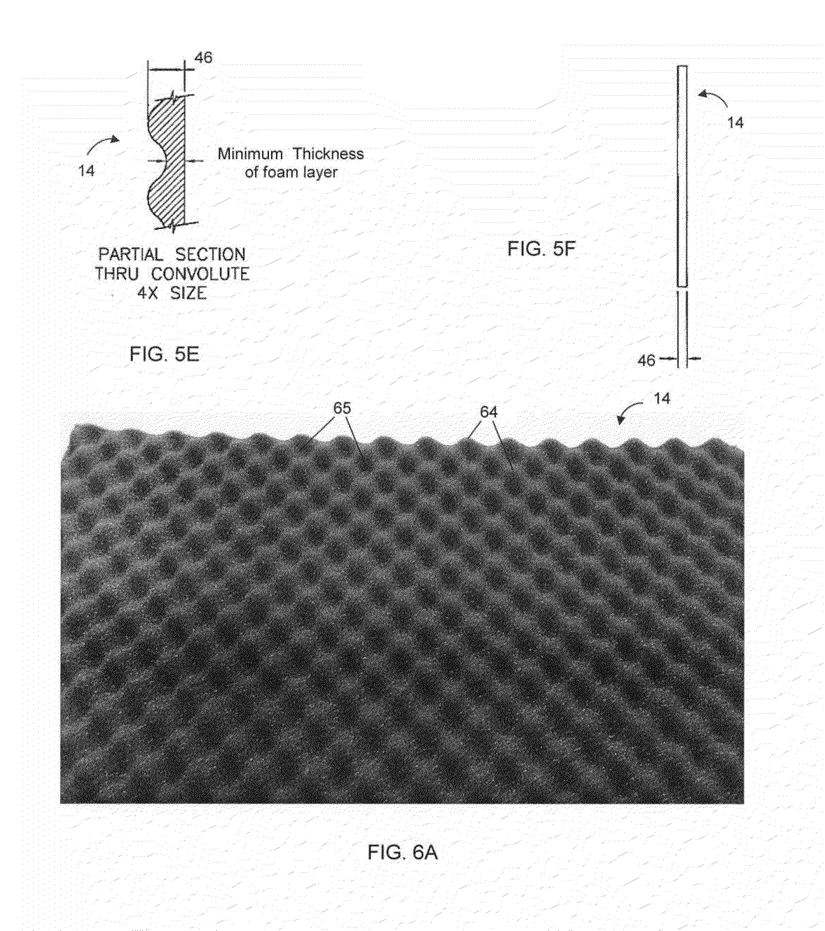

An illustrative composite article 10 having a plurality of reinforcing ribs and a textured surface is shown in FIG. 7.

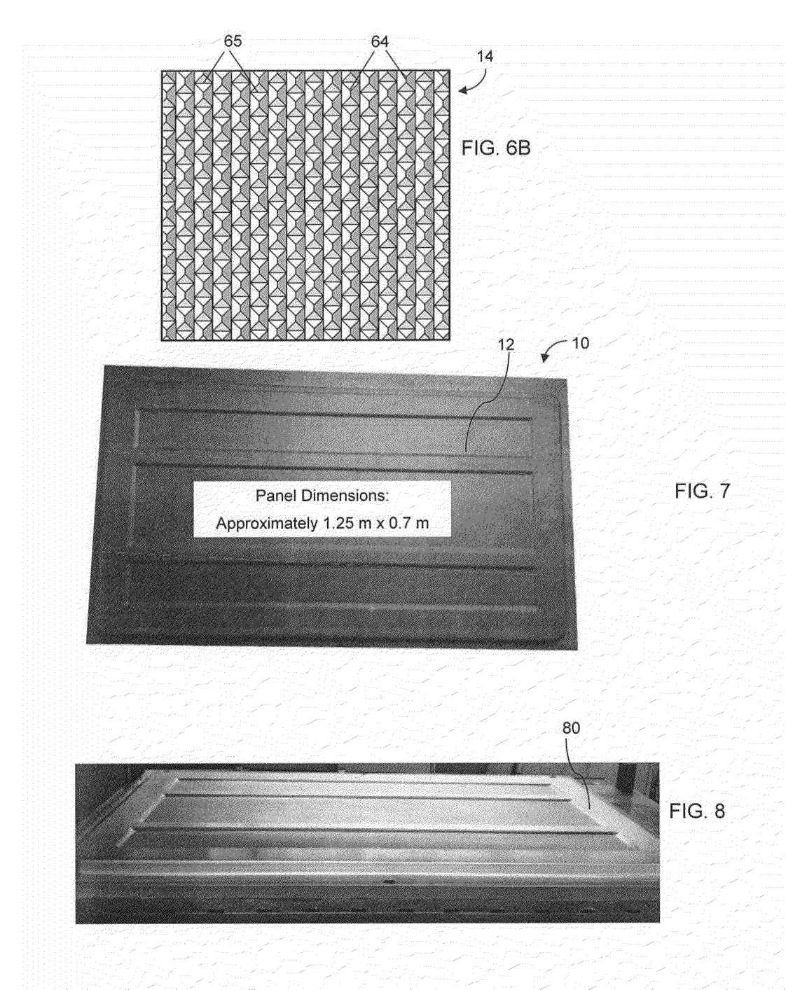

An illustrative tool that may be used for producing a reinforcing substrate layer according to the teachings herein is shown in FIG. 8. The method for producing a reinforcing substrate layer may include a step of pressing a composite material (preferably at a sufficiently high temperature that the thermosetting polymer cures), such as between two or more molds. Preferably, the method includes a step of molding that results in a panel that has one or more reinforcing structures molded into the reinforcing substrate layer.

An illustrative foam layer 14 according to the teachings herein is shown schematically in FIG. 5. The foam layer 14 preferably has a first side 50 for disposing onto a reinforcing substrate layer 12 (not shown) and a second opposing side 52. The first side 50 may be generally flat, or may have a contour. Preferably, the first side 50 is generally flat. The second side 50 may be generally flat, or may have a contour. Preferably, the second side 52 has a contour, so that the total surface area of the second side 52 is greater than the total surface area of the first side 50.

The foam layer 14 may be attached directly or indirectly to the reinforcing substrate layer 12. For example the foam layer 14 may be attached to the reinforcing substrate layer 12 using an adhesive layer, the foam layer may be heat bonded to the reinforcing substrate layer 12, or both. The foam layer preferably is attached to a sufficiently large portion of the reinforcing substrate layer so that the foam layer remains in place during handling and use of the article. As such, there may be regions of the foam layer, where the foam layer is not directly attached to the reinforcing substrate layer. For example, a reinforcing substrate layer that includes a region with a rib or other raised section may have a gap, such as a air gap, between the foam layer and the reinforcing substrate layer in that region.

### EXAMPLES

### Example 1

Example 1 is a wood composite panel that is prepared by attaching a foam having an average thickness of about 4 mm to a plywood having a thickness of 6 mm using a layer of adhesive. The wood composite panel has a height of about 1.4 m, and a width of about 0.7 m. The wood composite panel is capable of covering an opening of about 1.35 m×about 0.65 m. Such an opening is sufficiently large for a typical person to pass through. Sound transmission is measured through the wood composite panel and the loss in sound is measured in dB. The wood composite panel is too heavy for a single person to easily handle and requires two people to install and remove. The plywood composite panel is tested according for flammability according to FMVSS-302. The plywood composite panel does not pass FMVSS-302 class A, class B, or class C.

### Example 2

Example 2 is a glass fiber composite panel that is prepared according to the method of Example 1, except the plywood is replaced with a sheet of glass fiber reinforced polypropylene containing about 65 volume % glass and about 35 volume % polypropylene. The thickness of the glass fiber reinforced polypropylene is about 5 mm, and is expected to have about the same stiffness as the 6 mm thick plywood. The sound transmission of the glass fiber composite panel is expected to be about the same as, or even greater than the sound transmission of the plywood panel. The glass fiber reinforced panel is not expected to pass FMVSS-302 class C flammability requirements. The glass fiber reinforced panel is expected to be too heavy for a single person to easily handle and is expected to require two people to install and/or remove.

### Example 3

Example 3 is a natural fiber composite panel that is prepared according to the method of example 1, except the plywood is replaced with a reinforced substrate layer. The reinforced substrate layer is prepared by impregnating a mat of natural fibers with an aqueous dispersion of a styrene-acrylic polymer modified with a polycarboxylic acid and a polyol as a crosslinking component. The impregnating mat is partially cured and partially dried so that the impregnated mat can be handled as a solid. The impregnated mat is then cured in a mold having under sufficient pressure, time, and temperature to cure the polymer at least about 95%. The surface of the mold includes a texture and an embossed region so that the reinforced substrate layer has a textured surface and a region with a text/graphic. After curing and drying the polymeric phase, the reinforced substrate layer includes about 65 volume % natural fibers and about 35 volume % polymer. The thickness of the natural fiber reinforced composite is about 3 mm, and has about the same stiffness as the 6 mm thick plywood. The weight of the natural fiber reinforced panel including the foam layer is sufficiently low that a solitary person can easily handle, install, and remove it. The sound transmission is reduced compared with the plywood.

### Example 4

Example 4 is prepared using the same procedure as Example 3 except the polymer phase includes about 4-6 volume % of a halogenated flame retardant. The flammability of the reinforcing substrate layer of Example 4 is expected to be improved over Example 3, and is expected to passes FMVSS-302 class A.

### LISTING OF ELEMENTS

2 Opening
4 Chamber or wall having an opening
6 Inside of chamber
8 Sound or Sound source
10 Composite Article (such as a panel); preferably capable of covering the opening (e.g., capable of sealingly closing the opening to the chamber.
12 Reinforcing Substrate Layer
14 Foam Layer
16 Adhesive Layer (e.g., interposed between foam layer and reinforcing substrate layers)
20 Front (e.g. visible) surface of the reinforcing substrate layer
24 Embossed region
28 Molded-in color
30 Structural Feature
32 Rib
20 front surface of panel
22 rear surface reinforcing substrate layer
23 edge surface of panel
29 rear surface of panel
32 rib
36 Hole or other means for attaching panel to a structure
42 thickness of composite (e.g., about 28.575 mm)
44 thickness (e.g., wall thickness) of reinforcing substrate
46 thickness of foam layer (e.g., maximum thickness of foam layer)

What is claimed is:

1. An article comprising:
i) a reinforcing substrate layer including a fiber phase and a polymer phase, having opposing first and second surfaces and a thickness of about 5 mm or less, the reinforcing substrate layer, wherein
the fiber phase includes one or more natural fibers,
the natural fibers are present at a concentration sufficiently high so that the reinforcing substrate layer has a stiffness at least 20% greater than the stiffness of the polymer,
the polymer phase has a glass transition temperature of about 100° C. or more, and the polymer phase is present at a sufficient amount to be a continuous phase,
the concentration of the polymer phase is about 10 weight percent or more, based on the total weight of the reinforcing substrate layer,
the reinforcing substrate layer reduces the transmission of one or more sounds having a frequency from about 20 Hz to about 20 kHz; and
the reinforcing substrate layer has a volume density of about 1.5 g/cm² or less; and
ii) a foam layer disposed on at least a portion of one or both of the first surface or the second surface of the reinforcing substrate layer, wherein the foam layer has a density of about 0.6 g/cm³ or less, and reduces the transmission of one or more sounds having a frequency from about 20 Hz to about 20 KHz;
so that the article reduces the transmission of a sound having a frequency in the range from about 20 Hz to about 20 kHz by about 10 dB or more.

2. The composite article of claim 1, wherein the polymer phase has a glass transition temperature of about 120° C. or more.

3. The composite article of claim 2, wherein the reinforcing substrate layer has a thickness of about 5 mm or less.

4. The composite article of claim 3, wherein the natural fibers are present at a concentration of about 60 weight percent or more, based on the total weight of the reinforcing substrate layer.

5. The composite article of claim 4, wherein at least one of the first surface or the second surface of the reinforcing substrate layer is substantially covered by the foam layer.

6. The composite article of claim 5, wherein the reinforcing substrate layer includes one or more structures that reinforces the article in one or more directions.

7. The composite article of claim 5, wherein one or more surfaces of the reinforcing substrate layer has a decorative surface.

8. The composite article of claim 5, wherein the article is substantially free of any reinforcing members other than the reinforcing substrate layer; and the reinforcing substrate layer has an area density of about 2,200 g/m² or less.

9. The composite article of claim 1, wherein the reinforcing substrate layer, the foam layer, or both, includes a sufficient quantity of one or more flame retardants so that the article passes FVMSS-302, E84 Class A burn test.

10. The composite article of claim 1, wherein the article has a sufficient length and width so that article can cover an opening sufficiently large for a person to pass through.

11. The composite article of claim 1, wherein the foam layer is attached to the substrate layer using an adhesive, a heat bond, or both; the reinforcing substrate layer includes a dye, pigment, or other colorant; and the reinforcing substrate layer has a volume density of about 1.3 g/cm³ or less.

12. The composite article of claim 5, wherein the reinforcing substrate layer has a volume density of about 1.15 g/cm³ or less; the reinforcing substrate layer is substantially non-porous; the reinforcing substrate layer generally maintains its shape after 168 hours at 150° C. and 97% humidity; and the reinforcing substrate layer has a flexural modulus of about 60 MPa or more.

13. The composite article of claim 5, wherein the composite article is substantially free of glass fibers; the composite article is substantially free of fibers having a specific gravity greater than about 2; and the natural fibers are dyed.

14. The composite article of claim 5, wherein the article has an initial length and an initial width at about 25° C., and after heating the article to 100° C. for 120 minutes followed by cooling the article to 25° C., the article has a final length that is within 5% of the initial length and a final width that is within 5% of the initial width.

15. The composite article of claim 5, wherein the polymer phase includes one or more polymers having an ethylinically unsaturated monocarboxylic acid, a dicarboxylic acid, a dicarboxylic anhydride, or any combination thereof.

16. The composite article of claim 15, wherein the polymer phase includes an acrylic acid copolymer.

17. The composite article of claim 16, wherein the acrylic acid copolymer is a copolymer of acrylic acid and styrene.

18. An access panel including a composite of claim 1, wherein the access panel has a length of about 800 mm or more and a width of about 300 mm or more; the reinforcing substrate layer has a thickness from about 2 to about 3 mm; and the area density of the composite article is about 1,400 g/m² or less.

19. A process for preparing the composite article of claim 1 comprising the steps of:
i) impregnating a mat with a polymer solution, wherein the mat includes one or more natural fibers and has open spaces, and the polymer solution includes one or more polymers and a sufficient amount of water so that the polymer solution can flow into the open spaces of the mat to form an impregnated mat;
ii) partially drying the impregnated mat to form a dried impregnated mat, wherein the dried impregnated mat is sufficiently dried to reduce the water concentration and/or partially cure the polymer so that the dried impregnated mat can be handled as a solid and so that the polymer does not flow out of the mat, wherein the concentration of water in the dried impregnated mat is about 10 wt. % or more, based on the total weight of the water and the one or more polymers, so that the polymer can be cured to a higher level of cure, so that the polymer can be cured at lower temperatures, or both;
iii) curing the polymer in a mold under pressure and at a sufficiently high curing time and curing temperature so that the polymer has a glass transition temperature greater than about 100° C., and the impregnated mat becomes a reinforcing substrate,
so that a light weight composite article is formed.

20. The process of claim 19, wherein the mold is a vented mold so that water can be removed; wherein the difference in the concentration of water in the impregnated mat before molding and the concentration of water in the impregnated mat after molding is about 10 wt. % or more, wherein the concentration of water is based on the total weight of the water and the one or more polymers of the polymer solution; wherein the curing temperature is about 150° C. or more; dried impregnated mat includes about 15 weight percent or more water; and the polymer solution includes a curing agent that includes a polyol.
